(19) United States
(12) Patent Application Publication
(10) Pub. No.: US 2026/0018009 A1
(43) Pub. Date: Jan. 15, 2026

(54) COIN STORAGE DEVICE AND COIN PROCESSING DEVICE

(71) Applicant: GLORY LTD., Himeji-shi (JP)

(72) Inventor: Takumi Ito, Hyogo (JP)

(21) Appl. No.: 19/336,580

(22) Filed: Sep. 23, 2025

Related U.S. Application Data
(63) Continuation of application No. PCT/JP2024/012180, filed on Mar. 27, 2024.

(30) Foreign Application Priority Data
Mar. 31, 2023 (JP) 2023-057924

(51) Int. Cl. G07D 9/00; G07D 1/02

(52) U.S. Cl. CPC G07D 9/008; G07D 1/02; G07D 2201/00

(57) ABSTRACT

A coin storage device according to an aspect of the present disclosure comprises: a pair of side walls at least one of which is disposed in a tilted manner such that a distance between the side walls decreases as the side walls extends downward; and a transport mechanism disposed between the pair of side walls and configured to form a storage space configured to store a coin together with the pair of side walls. The transport mechanism comprises a first transport and a second transport, the first transport being disposed at a bottom portion of the storage space and configured to transport the coin toward a transport direction that is approximately horizontal and does not intersect the side wall, the second transport being configured to transport the coin substantially upward from the first transport.

### CROSS-REFERENCE TO RELATED APPLICATIONS

This application is a Continuation Application of PCT Application No. PCT/JP2024/012180, filed on Mar. 27, 2024, which is entitled and claims the benefit of Japanese Patent Application 2023-057924, filed on Mar. 31, 2023, the disclosures of which including the specification, drawings and abstract are incorporated herein by reference in its entirety.

### BACKGROUND ART

A coin storage device configured to store a coin and a coin processing device comprising the coin storage device are widely spread.

For example, a coin storing/dispensing unit is known, the coin storing/dispensing unit comprising: a storage frame that stores coins in a non-aligned state, an endless flat belt disposed at the bottom surface of the storage frame, and a reverse rotation roller disposed on the downstream side in the transport direction of the flat belt, the reverse rotation roller being configured to rotate in the opposite direction of the rotation direction of the flat belt to align and feed coins on the flat belt in a single layer and single row. The coin storing/dispensing unit disclosed can store and feed coins with a simple structure. In addition, through the rotation of the flat belt, the coins on the flat belt can be agitated and sent to the downstream side in the transport direction, and thus a space for accumulating other coins can be ensured on the flat belt, and as a result, the coin storage amount of the coin storing/dispensing unit can be increased.

### SUMMARY

A coin storage device according to an aspect of the present disclosure comprises: a pair of side walls at least one of which is disposed in a tilted manner such that a distance between the side walls decreases as the side walls extends downward; and a transport mechanism disposed between the pair of side walls and configured to form a storage space configured to store a coin together with the pair of side walls. The transport mechanism comprises a first transport and a second transport, the first transport being disposed at a bottom portion of the storage space and configured to transport the coin toward a transport direction that is approximately horizontal and does not intersect the side wall, the second transport being configured to transport the coin substantially upward from the first transport.

### BRIEF DESCRIPTION OF DRAWINGS

FIG. 1 is a schematic view illustrating an exemplary configuration of a coin processing device;

FIG. 2A is a schematic cross-sectional view of a coin storage device taken along a plane parallel to the front-rear direction and up-down direction;

FIG. 2B is a sectional view taken along a line A-A in FIG. 2A, and a schematic cross-sectional view of the coin storage device taken along a plane parallel to the left-right direction and up-down direction;

FIG. 3 is a conceptual view for describing an agitation operation by the coin storage device;

FIG. 4A is a sectional view of the coin storage device taken along a plane parallel to the front-rear direction and up-down direction;

FIG. 4B is a sectional view taken along a line B-B in FIG. 4A, and a sectional view of the coin storage device taken along a plane parallel to the left-right direction and up-down direction;

FIG. 5A is a diagram for describing a movement trajectory of a coin guided by a guide unit;

FIG. 5B is a diagram for describing an example of a method of calculating an installation angle θ of the guide unit;

FIG. 6 is a diagram for describing a protrusion provided on a surface of a belt;

FIG. 7A is a perspective view of a protrusion 33 that is separate from the belt in a case where the belt and the protrusion are separate members;

FIG. 7B is a diagram illustrating the belt and a hole before the protrusion is inserted;

FIG. 8 is a diagram specifically illustrating a structure in a region near an outlet of the coin storage device;

FIG. 9 is a schematic view illustrating an exemplary configuration of the coin processing device;

FIG. 10A is a diagram for describing a depositing operation in which a coin is deposited from the outside of the coin processing device;

FIG. 10B is a diagram for describing a dispensing operation using a coin reserved in a reservoir in the coin processing device;

FIG. 10C is a diagram for describing a dispense preparation operation in which a coin is supplied from the coin storage device to the reservoir;

FIG. 11 is a diagram for describing structures of a returning passage and a feeder; and

FIGS. 12A to 12C are diagrams for describing a structure of the returning passage.

### DESCRIPTION OF EMBODIMENTS

In the coin storing/dispensing unit, in the state where a large number of coins are accumulated on the flat belt, it is difficult to ensure the space for agitating coins. As such, a coin storage device that can efficiently agitate coins even in the state where a large number of coins are stored is desired.

An object of the present disclosure is to provide a coin storage device that can efficiently agitate coins even in the state where a large number of coins are stored is desired, and a coin processing device comprising the coin storage device.

In the coin storage device according to an aspect of the present disclosure, the pair of side walls may comprise a first side wall and a second side wall, and the first side wall may be disposed substantially vertically.

In the coin storage device according to an aspect of the present disclosure, the pair of side walls may comprise a first side wall and a second side wall, and the second side wall may be tilted at 45 degrees or greater.

The coin storage device according to an aspect of the present disclosure may further comprise: a third side wall disposed between the pair of side walls on an upstream side in the transport direction of the first transport in such a manner as to be orthogonal to each of the pair of side walls; and a curved surface disposed between the third side wall and the first transport and having a convex curved shape toward a rear side of the coin storage device.

In the coin storage device according to an aspect of the present disclosure, the transport mechanism may comprise a belt provided with a transport surface on which a protrusion configured to catch the coin during transport is formed, and a recess configured to avoid the protrusion may be formed at a lower end portion of the curved surface.

In the coin storage device according to an aspect of the present disclosure, an interval of the protrusion along the transport direction may be more than twice a diameter of the coin with the largest diameter to be stored.

In the coin storage device according to an aspect of the present disclosure, a length from an upstream end portion to a downstream end portion of the first transport along the transport direction may be smaller than a length from a lower end portion to an upper end portion of the second transport.

In the coin storage device according to an aspect of the present disclosure, a length from an upstream end portion to a downstream end portion of the first transport along the transport direction may be more than twice a diameter of the coin with the largest diameter to be stored.

The coin storage device according to an aspect of the present disclosure may further comprise: a reception unit provided at an upper portion of the coin storage device and configured to receive the coin; and a guide unit disposed at a position where the coin received via the reception unit hits, the guide unit being disposed at an installation angle at which the coin is repelled toward the first transport.

In the coin storage device according to an aspect of the present disclosure, the opening may be larger than the diameter of the coin with the largest diameter to be stored.

The coin storage device according to an aspect of the present disclosure may further comprise: an outlet provided near an upper end portion of the second transport and comprising an opening configured to eject the coin transported by the second transport; and a lid part provided at the outlet and configured to seal the opening.

In the coin storage device according to an aspect of the present disclosure, the transport mechanism may comprise a belt provided with a transport surface on which a protrusion configured to catch the coin during transport is formed, and a recess configured to avoid the protrusion may be formed at a lower end portion of the lid part.

In the coin storage device according to an aspect of the present disclosure, the opening may be larger than a diameter of the coin with the largest diameter to be stored.

A coin processing device according to an aspect of the present disclosure comprises: the above-described coin storage device; a transport mechanism which transports the coin; and a feeder which feeds to the transport mechanism the coin ejected from the coin storage device, and the outlet, to which the coin storage device ejects the coin, is connected to an interior of the feeder.

In the coin processing device according to an aspect of the present disclosure, the coin storage device may be detachable from the coin processing device.

The coin processing device according to an aspect of the present disclosure may further comprise: a reservoir which reserves a dispensing coin; and a control circuit which closes the lid part provided between the outlet and the feeder during a dispensing operation or during a coin depositing operation to the coin processing device, the control circuit being configured to open the lid part during a dispense preparation operation of feeding coin to be used for the dispensing operation from the feeder to the reservoir.

According to the present disclosure, coins can be efficiently agitated even in the state where a large number of coins are stored is desired.

Hereinafter, embodiments of the present disclosure will be described in detail with reference to the drawings. However, detailed descriptions of well-known matters and redundant descriptions of substantially identical configurations may be omitted. Further, for components common to the embodiments, the same reference numerals may be used and redundant descriptions may be omitted.

### First Embodiment

### Example Configuration of Coin Processing Device 1

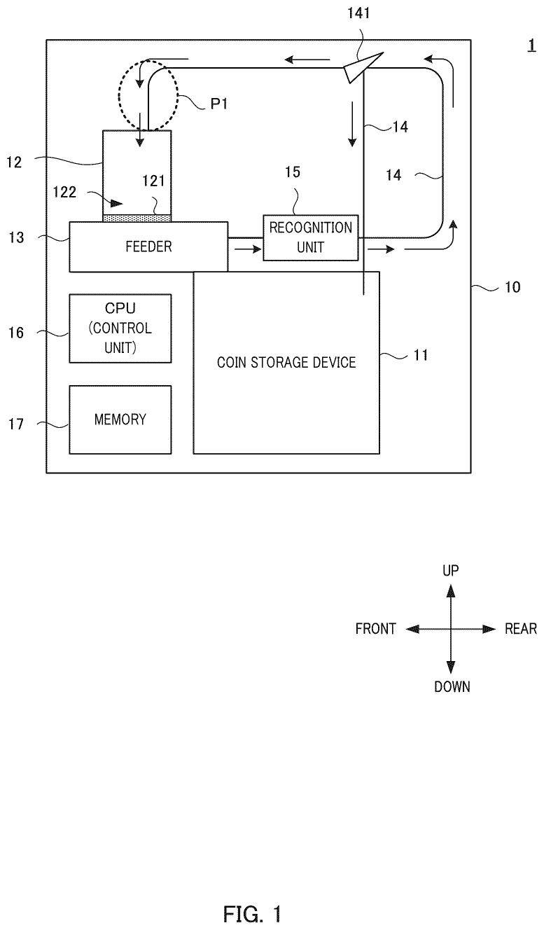

FIG. 1 is a schematic view illustrating an exemplary configuration of a coin processing device 1. As illustrated in FIG. 1, the coin processing device 1 comprises a coin storage device 11, a returning passage 12, a feeder 13, a transport unit 14, a recognition unit 15, a CPU 16, a memory 17, and a housing 10 that accommodates the above-mentioned components.

Note that, in the following description for the coin processing device 1, the front-rear direction and up-down direction illustrated in FIG. 1 may be used. The front-rear direction illustrated in FIG. 1 is a direction in which the side on which the feeder of the coin processing device 1 is disposed is the front side, and the side on which the coin storage device 11 is disposed is the rear side. In addition, the up-down direction illustrated in FIG. 1 is the direction in the state where the coin processing device 1 is installed. In addition, as described later, in the following description, the left-right direction is a direction when the coin processing device 1 is viewed from the front side.

It should be noted that the front-rear direction, up-down direction, and left-right direction illustrated in FIG. 1 are defined for convenience of explanation and are not intended to specify the front-rear, up-down, and left-right directions of the coin processing device according to the present disclosure. That is, the coin processing device according to the present disclosure does not necessarily have to be installed in accordance with the front-rear and up-down directions as illustrated in FIG. 1. The same applies to the left-right direction.

Under the control of the CPU 16, the coin storage device 11 stores coins handled in the coin processing device 1. The coin processing device 1 can store coins of a plurality of denominations in a mixed state, for example. In addition, the coin storage device 11 ejects the stored coins under the control of the CPU 16. The coin storage device 11 is disposed adjacent to the feeder 13. In this manner, the coins ejected from the coin storage device 11 are delivered into the feeder 13.

The coin storage device 11 may be detachable from the coin processing device 1, for example. A grip handle may be provided on the outside of the coin storage device 11 for the purpose of detaching from the coin processing device 1.

The feeder 13 sequentially feeds coins ejected from the coin storage device 11 or a reservoir 122 to the transport unit 14 one by one. The feeder 13 is provided in contact with the lower side of the reservoir 122, for example. In this manner, coins ejected from the coin storage device 11 or the reservoir 122 are immediately delivered into the feeder 13, and thus feeding from the coin storage device 11 or the reservoir 122 to the transport unit 14 can be quickly performed.

The transport unit 14 forms a transport path for transporting coins. The transport path comprises a circulating path configured in a loop shape, and is connected such that a coin fed from the feeder 13 can be delivered into the feeder 13 again. The transport unit 14 is composed of a belt provided around a plurality of pulleys, for example. The transport unit 14 transports a coin fed from the feeder 13 along the transport path under the control of the CPU 16. In FIG. 1, the arrows indicate movement paths of coins in the coin processing device 1.

The transport unit 14 is provided with a diversion part 141. Under the control of the CPU 16, the diversion part 141 delivers a coin fed from the feeder 13 into the coin storage device 11, or returns it to the feeder 13 through the returning passage 12.

The returning passage 12 for transferring coins is provided between a point P1, which is a part of the circulating path, and the feeder 13. The returning passage 12 is a space connecting the point P1 and the feeder 13 and is provided on the lower side of the point P1 substantially along the up-down direction, for example. A coin transported to the point P1 of the circulating path falls inside the returning passage 12 with gravity, and is thus returned to the feeder 13, for example. The returning passage 12 forms a transport path together with the transport unit 14.

The returning passage 12 is provided with an openable and closable shutter 121. The returning passage 12 is provided on the upper side of the feeder 13. The shutter 121 is provided at a terminal end of the returning passage 12 and between the returning passage 12 and the feeder 13, for example. The shutter 121 opens and closes under the control of the CPU 16.

In the state where the shutter 121 is closed, the fall of the coin in the returning passage 12 is blocked by the shutter 121. In this manner, the coins in the returning passage 12 accumulate on the shutter 121. In other words, the returning passage 12 and the shutter 121 in a closed state form the reservoir 122 that reserves coins before input to the feeder 13.

The reservoir 122 stores coins handled by the coin processing device 1. The reservoir 122 can store coins of a plurality of denominations in a mixed state, for example. The reservoir 122 stores some of coins ejected from the coin storage device 11. The coins stored in the reservoir 122 are used as a change fund, for example.

On the other hand, when the shutter 121 is opened under the control of the CPU 16, the coins accumulated on the shutter 121 fall into the feeder 13 since the returning passage 12 is provided on the upper side of the feeder 13.

With this configuration, a coin returned to the feeder 13 among the coins transported by the transport unit 14 is reserved in the reservoir 122 composed of the returning passage 12 and the shutter 121 when the shutter 121 of the returning passage 12 is closed. In this manner, the coins can be reserved in the reservoir 122 until an appropriate timing for returning the coin to the feeder 13 arrives. When an appropriate timing for returning the coin to the feeder 13 arrives, the shutter 121 is opened by the CPU 16, and the coins accumulated on the shutter 121 are returned to the feeder 13. In this manner, the coins that should be returned to the feeder 13 can be returned at an appropriate timing with a simple configuration and control.

The recognition unit 15 is provided on the circulating path of the transport unit 14. The recognition unit 15 recognizes the denomination, authentication, fitness and the like of coins fed from the feeder 13. The recognition unit 15 may have a function of counting the number of coins transported by the transport unit 14. The recognition unit 15 comprises at least one sensor selected from the group consisting of optical sensors such as imaging elements and line sensors, magnetic sensors, capacitance sensors, and weight sensors.

The central processing unit (CPU) 16 is a processor that controls the operation of each unit of the coin processing device 1. The CPU 16 is an example of the control circuit of the present disclosure.

The memory 17 records various types of information required for various operations of the coin processing device 1.

### Example Configuration of Coin Storage Device 11

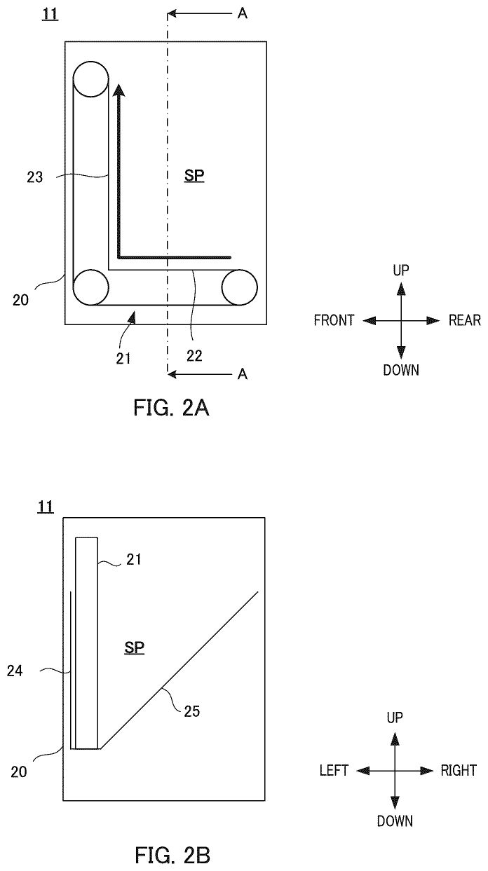

FIG. 2 are schematic views illustrating an exemplary configuration of the coin storage device 11. FIG. 2A is a schematic cross-sectional view of the coin storage device 11 taken along a plane parallel to the front-rear direction and up-down direction. FIG. 2B is a sectional view taken along a line A-A in FIG. 2A, and a schematic cross-sectional view of the coin storage device 11 taken along a plane parallel to the left-right direction and up-down direction. FIG. 2B is a diagram illustrating a cross-section taken along the line A-A as viewed from the rear side of the coin processing device 1.

As illustrated in FIGS. 2A and 2B, the coin storage device 11 comprises a transport mechanism 21 comprising a first transport 22 and a second transport 23, a pair of first side wall 24 and second side wall 25 disposed opposite to each other, and a housing 20 that accommodates the above-mentioned components. Note that, in FIG. 2A, the illustration of the first side wall 24 and the second side wall 25 is omitted.

The first side wall 24 and the second side wall 25, and the transport mechanism 21 make up a storage space for storing coins.

In the example illustrated in FIG. 2B, the first side wall 24 and the second side wall 25 are disposed such that the distance therebetween decreases as they extend downward. In addition, the first side wall 24 and the second side wall 25 are disposed parallel to the front-rear direction. The first side wall 24 is disposed substantially vertically, and the second side wall 25 is disposed in a tilted state. Note that, the present disclosure is not limited to this, and both the first side wall and second side wall may be disposed in a tilted state such that they come closer to each other as they extend downward, for example.

The transport mechanism 21 is disposed between the first side wall 24 and the second side wall 25. The transport mechanism 21 is composed of a plurality of pulleys, a belt provided around the pulleys, a motor that drives the belt, and the like, for example. The transport mechanism 21 transports coins stored in a storage space SP.

The first transport 22 makes up at least a part of the bottom portion of the storage space. The first transport 22 transports coins toward an approximately horizontal transport direction that does not intersect the first side wall 24 and the second side wall 25. In the example illustrated in FIG. 2A, the transport direction is a direction from the rear side to the front side of the coin storage device 11. The second transport 23 transports coins approximately upward from the first transport 22. In this manner, among the coins in the storage space SP, the transport mechanism 21 can transport the coins on the first transport 22 to the second transport 23 side, and then transport them approximately upward from the lower end portion to the upper end portion through the second transport 23. The coins transported from the lower end portion to the vicinity of the upper end portion of the second transport 23 are ejected to the outside of the coin storage device 11 from an outlet.

In the example illustrated in FIG. 2A, the coin transport direction of the first transport 22 is a horizontal direction from the rear side to the front side of the coin storage device 11, but the present disclosure is not limited to this. In the present disclosure, the transport direction of the first transport may not be exactly horizontal, and may be slightly shifted from the horizontal direction.

In addition, in the example illustrated in FIG. 2A, the coin transport direction of the second transport 23 is a vertical direction from the lower side to the upper side of the coin storage device 11, but the present disclosure is not limited to this. In the present disclosure, the transport direction of the second transport may not be exactly vertical, and may be slightly shifted from the vertical direction.

In this manner, in the coin storage device 11 of the first embodiment, the transport mechanism 21 is disposed between the first side wall 24 and the second side wall 25, at least one of which is tilted such that the distance therebetween decreases as they extend downward. The first side wall 24 and the second side wall 25, and the transport mechanism 21 make up the storage space SP. The first transport 22 is disposed at the bottom portion of the storage space SP.

With this configuration, coins stored in the storage space SP can easily move toward the first transport 22 by the own weight along the second side wall 25 disposed in a tilted state. In this manner, the coins in the storage space SP can be easily agitated without accumulating coins on the second side wall 25 or at the bottom portion of the storage space.

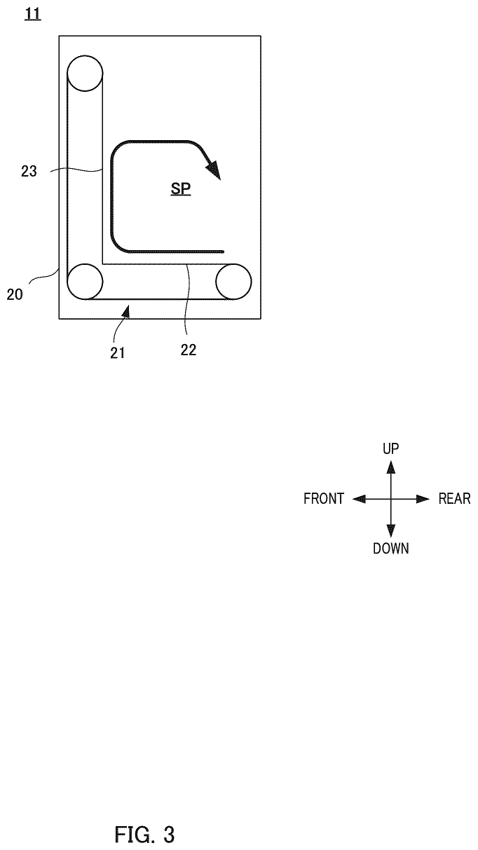

A coin guided onto the first transport 22 through the tilted second side wall 25 is transported to the second transport 23 by the first transport 22, and then transported upward by the second transport 23. At this time, as illustrated in FIG. 3, some coins transported upward fall into the storage space, and thus the coins can be provided with an up and down lifting movement, i.e., a rotating movement in the storage space SP as indicated by the arrow in FIG. 3. In this manner, even in the case where a large number of coins are stored in the storage space SP, the coins inside can be agitated while transporting the coins. FIG. 3 is a conceptual view for describing an agitation operation of the coin storage device 11.

In this manner, with the coin storage device 11 according to the first embodiment, a large number of coins can be stored, and the stored coins can be agitated while transporting them.

### Second Embodiment

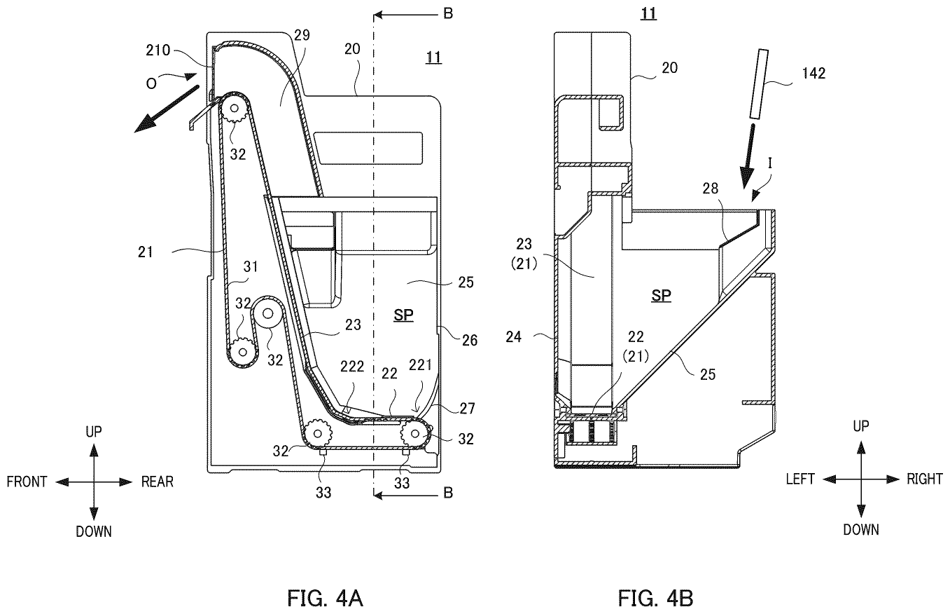

In a second embodiment, a configuration of the coin storage device 11 is further elaborated. FIG. 4 are sectional views illustrating an exemplary configuration of the coin storage device 11. FIG. 4A is a sectional view of the coin storage device 11 taken along a plane parallel to the front-rear direction and up-down direction. FIG. 4B is a sectional view taken along a line B-B in FIG. 4A, and a sectional view of the coin storage device 11 taken along a plane parallel to the left-right direction and up-down direction.

As described in the first embodiment, the transport mechanism 21 is disposed between the first side wall 24 disposed substantially vertically and the second side wall 25 disposed in a tilted manner. The transport mechanism 21 comprises the first transport 22 and the second transport 23. The first transport 22 transports coins along an approximately horizontal transport direction. The second transport 23 transports coins approximately upward from the first transport 22. The distance between the first side wall 24 and the second side wall 25 at a position where the first side wall 24 and the second side wall 25 are closest to each other is substantially equal to the width of the transport mechanism 21.

Since the second side wall 25 is tilted, coins on the second side wall 25 easily slides downward on the surface of the second side wall 25 by its own weight. In this manner, a situation where the coins in the storage space SP accumulate on the second side wall 25 can be avoided.

The inclination angle of the second side wall 25 needs only to be 45° or greater with respect to the horizontal direction, for example. Such an inclination angle can achieve an effect in which the coins less accumulate on the second side wall 25.

Now a reception unit I where the coin storage device 11 receives coins is described. As illustrated in FIG. 4B, the reception unit I is provided in the vicinity of the upper end portion of the second side wall 25. The reception unit I is an opening provided in the housing 20, and receives a coin transported to the coin storage device 11 via the diversion part 141 of the transport unit 14 illustrated in FIG. 1. More specifically, a coin transported to the coin storage device 11 via the diversion part 141 is output from a chute 142 provided at the front end of the transport unit 14 toward the reception unit I.

A guide unit 28 is provided inside the reception unit I of the coin storage device 11. The guide unit 28 is provided at a position where a coin output from the chute 142 to the coin storage device 11 hits and on the upper side of the storage space SP. The guide unit 28 guides the movement of a coin received via the reception unit I inside the coin storage device 11.

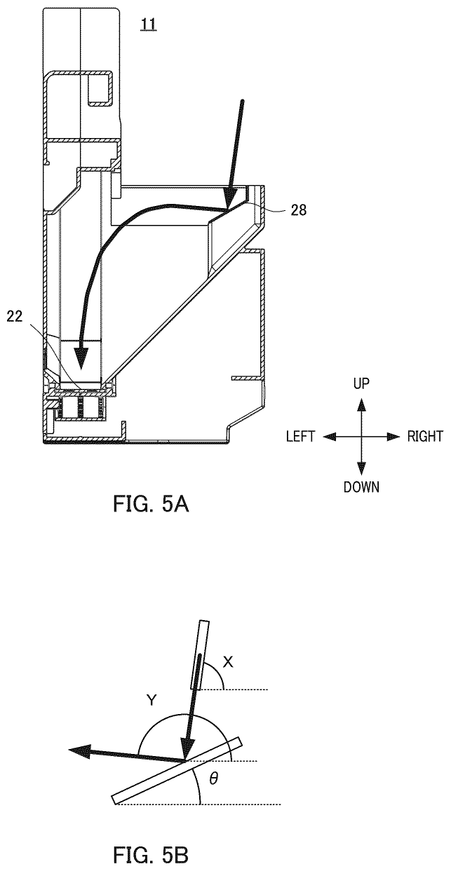

FIG. 5 is a diagram for describing a movement trajectory of a coin guided by the guide unit 28. As illustrated in FIG. 5A, a coin received from the reception unit I is repelled upon hitting the guide unit 28 and thus guided toward the first transport 22. This can avoid a situation where the coins cannot be transported by the transport mechanism 21 due to accumulation of coins received from the reception unit I on the tilted second side wall 25, for example. In addition, this can avoid a situation where coins are unevenly stored on the second side wall 25 and the like, and thus coins can be uniformly stored in the storage space SP. In this manner, the number of coins that can be stored in the storage space SP can be increased.

The position and installation angle (angle with respect to the horizontal plane) of the guide unit 28 are set on the basis of the position of the chute 142, the output angle (angle with respect to the horizontal plane) of the coin output from the chute 142, and the direction in which a coin repelled by the guide unit 28 should advance. FIG. 5B is a diagram for describing an example of a method of calculating an installation angle θ of the guide unit 28.

As illustrated in FIG. 5B, when X is the output angle of the coin output from the chute 142 and Y is an angle with respect to the horizontal plane of the direction in which a coin repelled by the guide unit 28 should advance, 0 is calculated by the following Equation 1, for example.

$$θ = ( X + Y - 1 \; 80 ) / 2 \qquad ( Equation 1 )$$

By setting the position and installation angle of the guide unit 28, the destination of the fall of the coin received from the reception unit I can be guided to the direction close to the first transport 22. In this manner, coins can be prevented from unevenly accumulating side by side on the tilted second side wall 25, and thus the number of coins that can be stored in the storage space SP can be substantially increased. Note that, the above-described Equation 1 is merely an example, and in the present disclosure, the installation angle of the guide unit 28 may be set by other methods.

Next, the transport mechanism 21 comprising the first transport 22 and the second transport 23 is elaborated. A coin transported by the first transport 22 is transported upward by the second transport 23. As illustrated in FIG. 4A, the second transport 23 is disposed in a slightly tilted manner with respect to the vertical direction (up-down direction in FIG. 4A) such that the distance from the first transport 22 increases as it extends upward. In this manner, a situation where a coin transported by the second transport 23 unintentionally falls can be reduced.

As illustrated in FIG. 4A, the length of the first transport 22 is smaller than that of the second transport 23. With the length of the first transport 22 formed with a smaller length, the entirety of the coin storage device 11 can be downsized. In addition, since the length of the first transport 22 is relatively shorter, the coins accumulated on the first transport 22 reach the second transport 23 in a short time after being transported by the first transport 22. Some of the coins moved upward by the second transport 23 is separated from the second transport 23 so as to return into the storage space SP. Specifically, with the first transport 22 and the second transport 23, some coins in a lower portion in the storage space SP are lifted up and returned into an upper portion of the storage space SP. In this manner, the coins in the storage space SP can be efficiently agitated.

The length from an upstream end portion 221 to a downstream end portion 222 of the first transport 22 may be set on the basis of the diameter of the coin with the largest diameter (hereinafter referred to as largest diameter coin) among the coins of a plurality of denominations handled in the coin processing device 1 (see FIG. 1), for example. More specifically, the length from the upstream end portion 221 to the downstream end portion 222 of the first transport 22 may be set to more than twice the diameter of the largest diameter coin (plus a predetermined margin length). The predetermined margin length needs only to be set to about 5 mm, for example. Note that, the upstream end portion 221 of the first transport 22 is the end portion on the right side in FIG. 4 of the first transport 22. The downstream end portion 222 of the first transport 22 is the end portion on the left side of the first transport 22 in FIG. 4, and is a connecting portion with the second transport 23.

As illustrated in FIG. 4A, the transport mechanism 21 is composed of a belt 31 and a plurality of pulleys 32. The belt 31 comprises a transport surface on which a protrusion 33 for catching coins during transport is formed. FIG. 4A illustrates only some of the protrusions 33; however, in actuality, the protrusions 33 are provided over the entire surface of the belt 31.

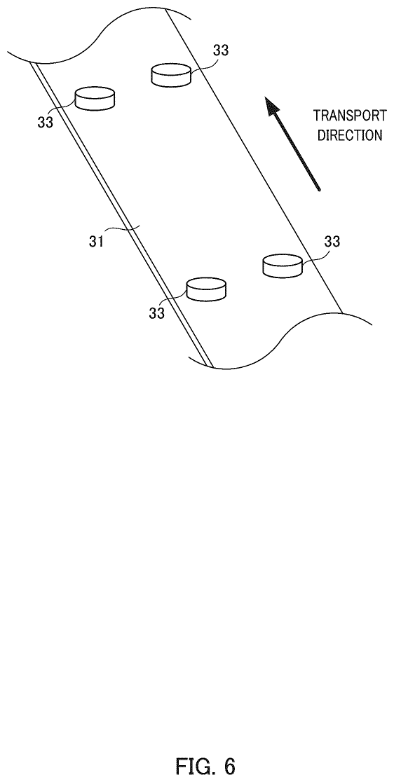

FIG. 6 is a diagram for describing the protrusions 33 provided on the surface of the belt 31. As illustrated in FIG. 6, two protrusions 33 are disposed side by side in a direction perpendicular to the transport direction. With this configuration, the protrusions 33 can catch and hold coins on the surface of the belt 31.

The protrusions 33 are disposed at a predetermined interval along a direction parallel to the transport direction. The predetermined interval may be set to more than twice the diameter of the largest diameter coin (plus a predetermined margin length), for example.

With the protrusions 33 disposed at the above-described interval, even the largest diameter coin can easily pass between the protrusions 33 disposed along the transport direction. In this manner, the transport mechanism 21 can easily transport the largest diameter coin. This can prevent a situation where coins easily fall from the second transport 23 when the second transport 23 transports coins upward, which can possibly occur in the case with a larger predetermined interval between the protrusions 33. In addition, in comparison with the case with a larger predetermined interval between the protrusions 33, the number of coins that can be transported for one rotation of the transport mechanism 21 can be increased. Further, since a small coin more easily passes between the protrusions 33 than a large coin, the sizes of the coins transported by the transport mechanism 21 may possibility become uneven; however, the above-described configuration can prevent a situation where the sizes of the transported coins become uneven.

The height of the protrusion 33 (the protrusion amount from the surface of the belt 31) needs only to be set on the basis of the thickness of the coin handled in the coin processing device 1. For example, the height of the protrusion 33 may be set to the thickness of two of the thickest coins.

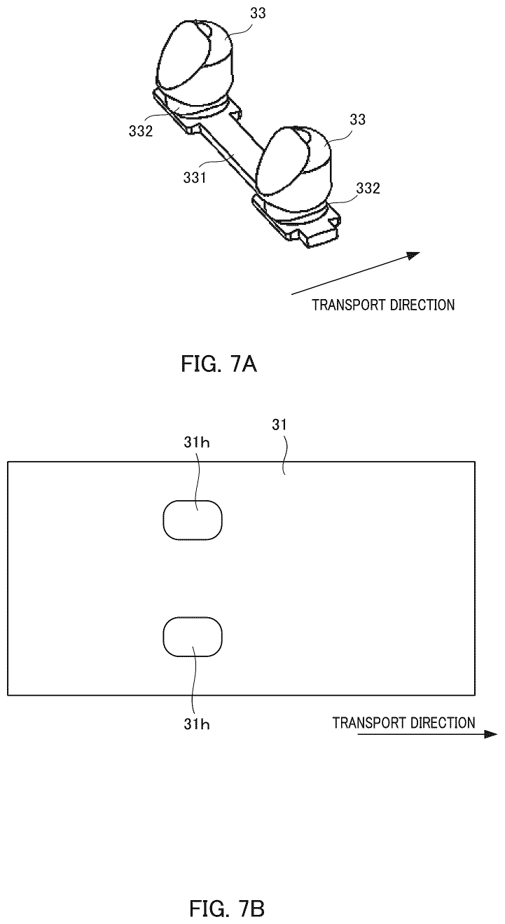

The protrusion 33 may be configured separately from the belt 31, for example. In this case, a plurality of holes 31h are formed in the belt 31, and the protrusions 33 are inserted from the rear side of the belt 31 through the holes 31h such that they protrude to the surface side of the belt 31. FIG. 7 are diagrams illustrating an example of the belt 31 and the protrusion 33 in the case where the belt 31 and the protrusion 33 are separate members. FIG. 7A is a perspective view of the protrusions 33 that are separate from the belt 31. The transport direction illustrated in FIG. 7A corresponds to a transport direction in the state where the protrusions 33 protrude from the surface of the belt 31. FIG. 7B is a diagram illustrating the holes 31h of the belt 31 before the protrusions 33 are inserted.

In the example illustrated in FIG. 7B, a pair of the holes 31h are disposed side by side in a direction perpendicular to the transport direction. In the surface of the belt 31, a plurality of the holes 31h is provided along the transport direction.

In the example illustrated in FIG. 7A, the pair of protrusions 33 inserted to the pair of holes 31h are coupled with each other by a coupling part 331. In addition, the protrusion 33 and the coupling part 331 are connected to each other by a constriction portion 332 with a smaller diameter than the protrusion 33. The distance between the pair of protrusions 33 coupled with each other by the coupling part 331 is substantially the same as the distance between the pair of holes 31h.

When a coin is transported with the protrusion 33 catching the coin, a force is applied to the protrusion 33 in the direction opposite to the transport direction. In some situation this force may act in a rotating direction with the point where the protrusion 33 makes contact with the hole 33h as a fulcrum. In the case where the protrusions 33 protrude from the pair of holes 31h in the state of being coupled with each other by the coupling part 331, it is possible to prevent a situation where the protrusion 33 is rotated and removed from the hole 33h due to the above-mentioned force.

In the state where the protrusion 33 protrudes from the surface of the belt 31, the constriction portion 332 is disposed at the same height as the hole 31h in the direction perpendicular to the surface of the belt 31. In other words, the constriction portion 332 is fitted into the hole 31h. The shapes of the constriction portion 332 and the hole 31h are formed with corners such that the constriction portion 332 does not rotate with respect to the hole 31h in a plane including the surface of the belt 31. The corners may be rounded.

The width of the constriction portion 332 along a direction perpendicular to the transport direction in the state where it is fitted in the hole 31h is slightly smaller than the width of the hole 31h along a direction perpendicular to the transport direction. One of the constriction portions 332 of the pair of protrusions 33 may be slightly smaller than the width of the corresponding hole 31h. The length of the constriction portion 332 along the transport direction in the state where it is fitted in the hole 31h is substantially the same as the length of the hole 31h along the transport direction.

The distance between the pair of protrusions 33 coupled with each other by the coupling part 331 may vary due to processing errors in some cases. With the above-described shape, in the state where the constriction portion 332 is fitted in the hole 31h, the constriction portion 332 can move inside the hole 31h in a direction perpendicular to the transport direction, and thus the variations in distance between the pair of protrusions 33 can be accommodated. Note that, in the case where processing accuracy is high and there is no variation in distance between the pair of protrusions 33, the shape of the constriction portion 332 may have no corners, and the width of the constriction portion 332 along a direction perpendicular to the transport direction may be the same as the width of the hole 31h along a direction perpendicular to the transport direction.

Next, the following describes a third side wall 26 provided between the first side wall 24 and the second side wall 25, and a curved surface 27 provided between the third side wall 26 and the first transport 22.

On the upstream side of the first transport 22 in the transport direction, and between the pair of side walls (the first side wall 24 and the second side wall 25), the third side wall 26 orthogonal to each of the pair of side walls is provided. The third side wall 26 is disposed immediately inside the exterior wall on the rear side of the housing 20 along the exterior wall on the rear side of the housing 20, for example. Together with the first side wall 24, the second side wall 25, and the transport mechanism 21, the third side wall 26 makes up the storage space SP.

A gap is formed between the third side wall 26 and the upstream end portion 221 of the first transport 22 in the transport direction in order to ensure a space for installing the pulley 32 making up the transport mechanism 21, and a space for moving the belt 31 wound around the pulley 32. To prevent coins from entering that gap, the curved surface 27 is provided between the third side wall 26 and the upstream end portion 221 of the first transport 22. As illustrated in FIG. 4A, in a cross section taken along a plane parallel to the front-rear direction and up-down direction, the curved surface 27 has a convex curved shape toward the rear side of the coin storage device 11.

When a coin lifted up by the second transport 23 and returned to the storage space SP hits the third side wall 26 and slides downward, the curved surface 27 having that curved shape serves as a guide for the coin to easily return onto the first transport 22. With this configuration, the coin storage device 11 can efficiently agitate coins in the storage space SP.

Note that, the lower end portion of the curved surface 27 is formed in conformity with the surface shape of the belt 31 of the transport mechanism 21. More specifically, at the lower end portion of the curved surface 27, a recess for avoiding the protrusion 33 provided on the surface of the belt 31 is formed. In this manner, the lower end portion of the curved surface 27 can be positioned close to the surface of the belt 31 in the first transport 22. In this manner, coins can be prevented from entering between the curved surface 27 and the first transport 22.

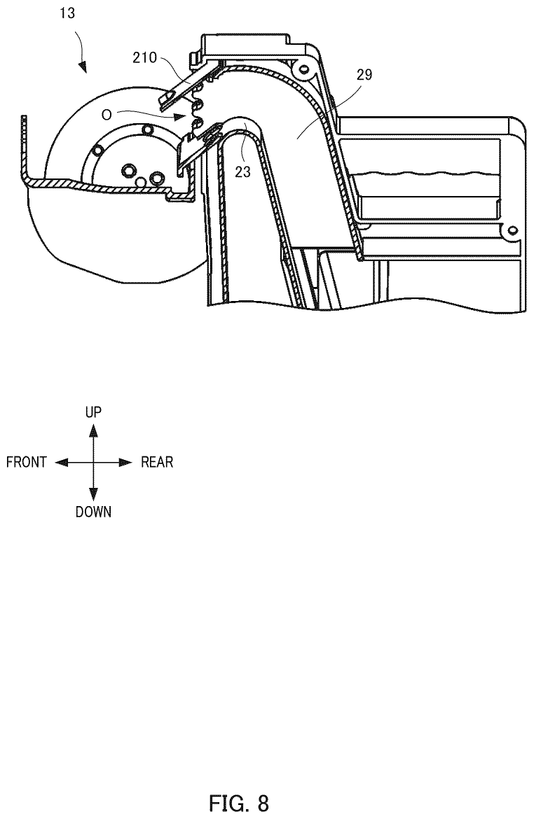

Next, an outlet O from which a coin transported upward by the second transport 23 is ejected to the outside of the coin storage device 11 is described. FIG. 8 is a diagram specifically illustrating a structure in a region near the outlet O of the coin storage device 11. FIG. 8 illustrates the second transport 23, an ejection passage 29 provided along the second transport 23, and a lid part 210 provided at the outlet O in an openable and closable manner.

The ejection passage 29 is a space provided on the surface side of the second transport 23. The cross section of the ejection passage 29 taken along a plane perpendicular to the transport direction of the coin has a quadrangular shape or circular shape, for example. The internal diameter of the ejection passage 29 is formed with a size slightly larger than the diameter of the largest diameter coin, for example. In this manner, even if a coin is separated from the second transport 23 while the coin is being transported by the second transport 23, a situation where the ejection passage 29 is clogged with the coin can be avoided.

The outlet O, which is an opening that is open toward the outside, is provided at the downstream end portion of the ejection passage 29 in the transport direction. The size of the outlet O is formed with a size slightly larger than the diameter of the largest diameter coin, for example. Note that, as described in the first embodiment, the coin storage device 11 is provided adjacent to the feeder 13 such that the coin ejected from the outlet O is directly delivered into the feeder 13. In other words, the outlet O of the coin storage device 11 is connected with the inside of the feeder 13.

The outlet O is provided with the openable and closable lid part 210. The lid part 210 opens and closes under the control of the CPU 16. More specifically, the lid part 210 is closed except when a coin is ejected from the coin storage device 11, and is opened at a timing when a coin is ejected from the outlet O. In this manner, the coin storage device 11 can feed coins to the feeder 13. In addition, it is possible to reduce a situation where a coin delivered from the inlet to the feeder 13 enters the coin storage device 11 from the outlet O other than when a coin is ejected.

### Third Embodiment

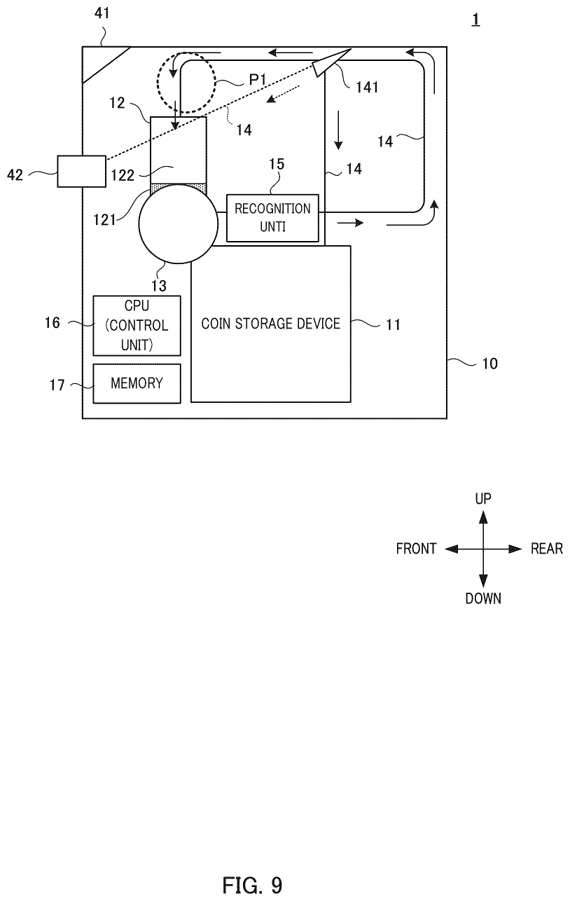

In a third embodiment, a configuration of the coin processing device 1 is further elaborated. FIG. 9 is a schematic view illustrating an exemplary configuration of the coin processing device 1.

The coin processing device 1 according to the third embodiment further includes a deposit unit 41 and a dispense unit 42 in addition to the configurations described in the first embodiment (see FIG. 1).

The deposit unit 41 is an opening that receives a deposit from the outside of the coin processing device 1. A coin deposited from the deposit unit 41 is moved to the feeder 13.

The dispense unit 42 is an opening for dispensing a coin to the outside of the coin processing device 1.

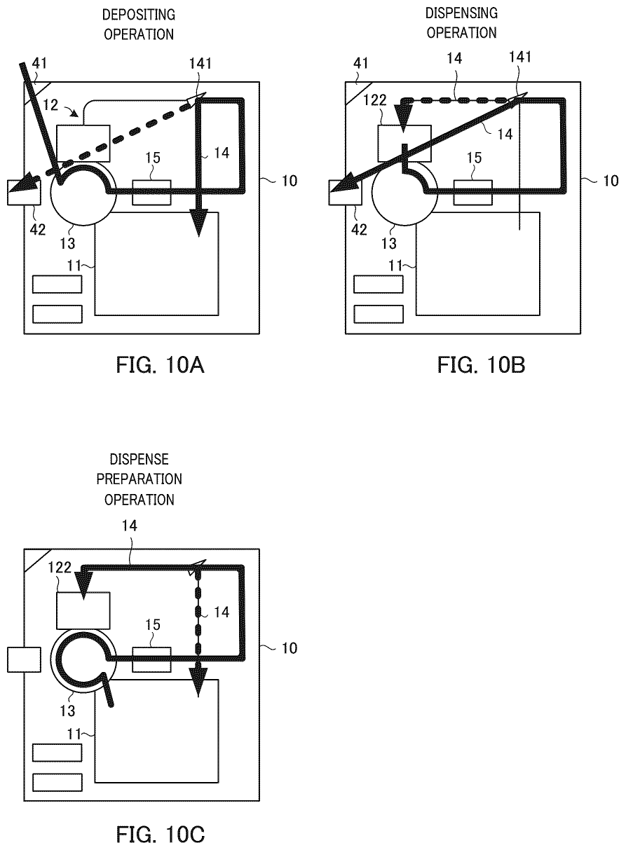

Next, specific examples of a usage mode of the coin processing device 1 are described. FIG. 10 are diagrams for describing a usage mode of the coin processing device 1. In FIGS. 10A to 10C, arrows indicate movements of coins inside the coin processing device 1 in respective different operations of the coin processing device 1. Note that, in FIGS. 10, a part of the returning passage 12 including the shutter 121 (see FIG. 9), and a part of the transport unit 14 are omitted.

FIG. 10A is a diagram for describing a depositing operation of depositing a coin from the outside of the coin processing device 1.

As illustrated in FIG. 10A, a coin deposited from the deposit unit 41 is delivered into the feeder 13 first. The feeder 13 feeds deposited coins to the transport unit 14 one by one. The fed coin is recognized by the recognition unit 15 above the transport unit 14.

The recognized coin is transported via the transport unit 14 and the diversion part 141 to the coin storage device 11 and stored in the coin storage device 11. Note that, in the case where the recognition unit 15 cannot recognize the coin, the coin is ejected to the outside of the device from the dispense unit 42 via the diversion part 141 as indicated by the broken arrow in FIG. 10A, for example. In addition, when abnormality occurs during transport such as when normal diversion cannot be performed due to abnormality such as belt lock, it is returned to the feeder 13 through the returning passage 12, for example. The coin returned to the feeder 13 is fed to the transport unit 14, and recognized again by the recognition unit 15.

Even in the case where a coin cannot be stored due to the full coin storage device 11, or a coin cannot be handled by the coin storage device 11 based on the recognition result in the depositing operation, the coin may be transported to the dispense unit 42 via the diversion part 141 so as to be refunded.

Next, FIG. 10B is a diagram for describing a dispensing operation using coins reserved in the reservoir 122 in the coin processing device 1. The reservoir 122 stores dispensing coins, such as change fund, to be dispensed to the outside of the coin processing device 1. When dispensing is requested, the coin processing device 1 dispenses the requested number of coins from the reservoir 122. This dispensing operation is performed when dispensing of a change is requested to the coin processing device 1 and the like, for example.

The reservoir 122 reserves dispensing coins of a combination of denominations set in advance by the dispense preparation operation described later. The combinations of denominations of dispensing coins reserved in the reservoir 122 can correspond to the change for all amounts, for example. As specific examples, the reservoir 122 preliminarily reserves four 1 yen coins, one 5 yen coin, four 10 yen coins, one 50 yen coin, four 100 yen coins, and one 500 yen coin. By appropriately combining the denominations and number of the coins stored in the above-mentioned manner, any amount of change from one yen to 999 yen can be provided.

In the dispensing operation, the shutter 121 is opened under the control of the CPU 16, and all coins reserved in the reservoir 122 are ejected to the feeder 13 as illustrated in FIG. 10B. The feeder 13 feeds received coins to the transport unit 14 one by one. The fed coin is recognized by the recognition unit 15 above the transport unit 14.

The CPU 16 selectively transports coins to the reservoir 122 or the dispense unit 42 on the basis of the recognition result of the recognition unit 15. More specifically, the CPU 16 determines whether to dispense recognized coins one by one, and when it is determined that coins are to be dispensed, the coins are transported to the dispense unit 42 via the transport unit 14 and dispensed. In addition, when the CPU 16 determines that the recognized coin is not to be dispensed, the CPU 16 returns the coin to the reservoir 122 via the transport unit 14 as indicated by the broken arrow in FIG. 10B. At this time, the CPU 16 performs the control to close the shutter 121 before the coin is transported to the returning passage 12.

The method of determining whether to dispense the recognized coin is not limited in the present disclosure. For example, the CPU 16 needs only to determine the amount to be dispensed per denomination on the basis of the requested dispense amount, determine that the coin is to be dispensed when the denomination of the coin recognized by the recognition unit 15 anew is a coin of a denomination that is to be further dispensed, and determine that the coin is not to be dispensed when the denomination of the coin is one that is not required to be dispensed.

Next, FIG. 10C is a diagram for describing a dispense preparation operation of supplying coins from the coin storage device 11 to the reservoir 122. The dispense preparation operation is an operation of supplying coins dispensed from the reservoir 122 by the above-described dispensing operation.

In the dispense preparation operation, coins are ejected from the coin storage device 11. From among the ejected coins, coins of a predetermined denomination are transported to the reservoir 122 in quantities corresponding to the predetermined denomination. At this time, the coin storage device 11 ejects the coins at random from among the coins to be stored, for example. Specifically, it is expected that the number of coins for each denomination included in the coins ejected by the coin storage device 11 is different for each dispense preparation operation.

The coins ejected from the coin storage device 11 are delivered into the feeder 13. The feeder 13 feeds deposited coins to the transport unit 14 one by one. The fed coin is recognized by the recognition unit 15 above the transport unit 14.

The CPU 16 determines whether to store the recognized coins one by one in the reservoir 122. When it is determined that the coins are to be stored, the CPU 16 transports the coin to the reservoir 122 and stores the coin therein. In addition, when it is determined that the recognized coins are not to be reserved in the reservoir 122, the CPU 16 returns the coin to the coin storage device 11 as indicated by the broken arrow in FIG. 10C.

In the above-described dispensing operation, the CPU 16 records in the memory 17 the denomination and the number of the dispensed coins. In the dispense preparation operation, the CPU 16 needs only to determine whether the recognized coin is to be transported to the reservoir 122, or to be returned to the coin storage device 11 on the basis of the record of the memory 17.

Hereinabove, exemplary operations of the coin processing device 1 are described. The following elaborates the returning passage 12 and the feeder 13 in the configuration of the coin processing device 1.

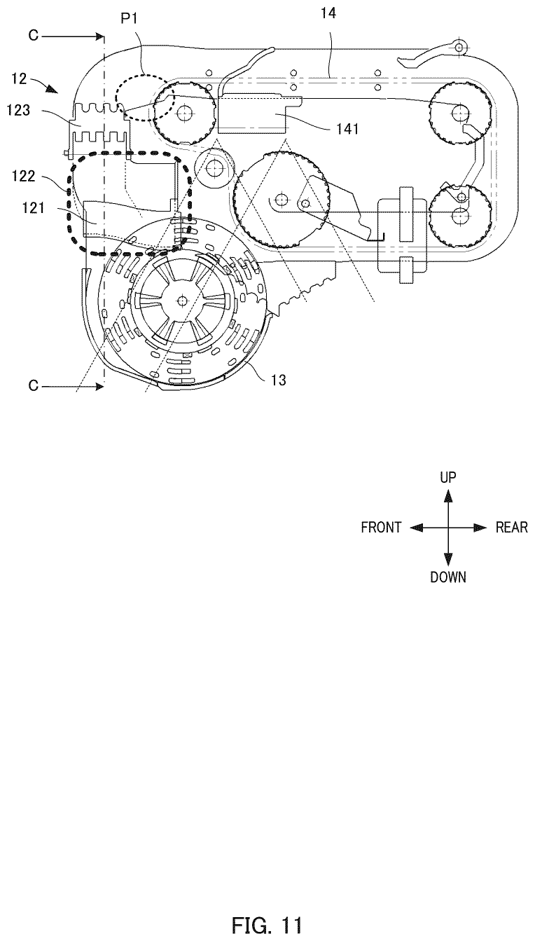

FIG. 11 is a diagram for describing structures of the returning passage 12 and the feeder 13. In FIG. 11, a circulating path making up the transport unit 14 is indicated by the chain double-dashed line. The returning passage 12 is a passage disposed between the point P1 on the front upper side of the circulating path and the feeder 13.

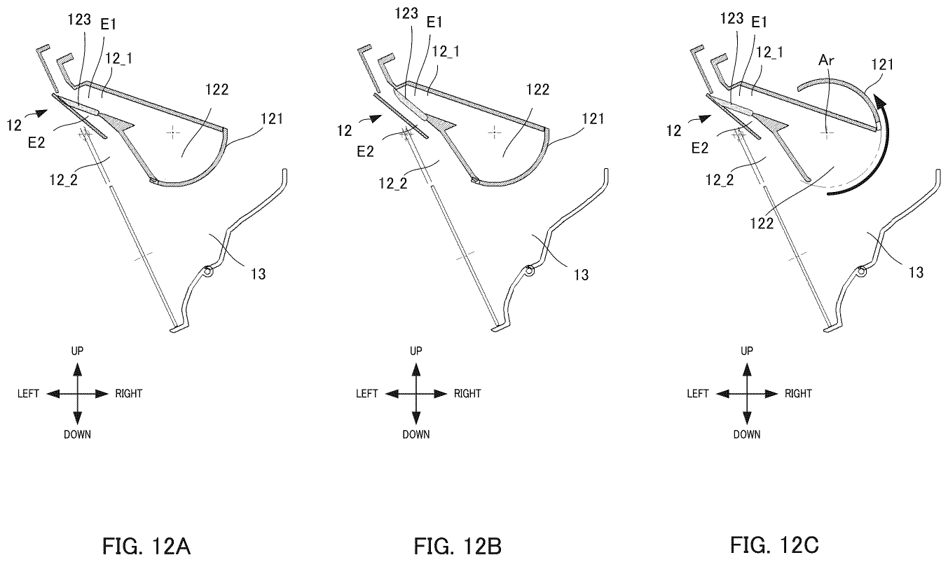

FIG. 12 are diagrams for describing of a structure of the returning passage 12. FIG. 12 are sectional views taken along line C-C of FIG. 11. FIGS. 12A to 12C are diagrams illustrating cross sections taken along the line C-C as viewed from the front side of the coin processing device 1.

As illustrated in FIG. 12, the returning passage 12 is diverted into two passages in the horizontal direction of the coin processing device 1. In the following description, the returning passage 12 on the right side is referred to as first passage 12_1, and the returning passage 12 on the left side is referred to as second passage 12_2. The first passage 12_1 and the second passage 12_2 are disposed parallel to each other. The first passage 12_1 is disposed along the top surface of the upper wall of the second passage 12_2. Specifically, the first passage 12_1 is disposed on the upper side of the second passage 12_2. A gate member 123 is provided at the diversion part of the first passage 12_1 and the second passage 12_2. The gate member 123, under the control of the CPU 16, closes one of a first entrance E1 of the first passage 12_1 and a second entrance E2 of the second passage 12_2 while opening the other. FIGS. 12A and 12C illustrate a state where the gate member 123 opens the first entrance E1 and closes the second entrance E2. FIG. 12B illustrates a state where the gate member 123 opens the second entrance E2 and closes the first entrance E1.

The first passage 12_1 is provided with the shutter 121. The shutter 121 and the first passage 12_1 make up the reservoir 122. Specifically, when the gate member 123 opens the first entrance E1, a coin delivered from the transport unit 14 into the returning passage 12 enters the first passage 12_1 and is reserved in the reservoir 122.

The shutter 121 is supported in the state where it is rotatable around a predetermined rotation axis. In the examples illustrated in FIGS. 12A to 12C, the shutter 121 is supported in the state where it is rotatable around a rotation axis Ar. The shutter 121 is formed in an arc shape in a cross section taken along a plane perpendicular to the rotation axis. In the examples illustrated in FIGS. 12A to 12C, the shutter 121 is formed in an arc shape in a cross section taken along a plane parallel to the left-right direction and up-down direction. The shutter 121 can open and close between the reservoir 122 and the feeder 13 through a rotation under the control of the CPU 16. FIGS. 12A and 12B illustrate a state where the shutter 121 is closed. FIG. 12C illustrates a state where the shutter 121 is opened.

On the other hand, the second passage 12_2 is not provided with the shutter, and a coin delivered from the transport unit 14 into the returning passage 12 is directly returned to the feeder 13 through the second passage 12_2.

In a depositing operation (see FIG. 10A), the CPU 16 controls the gate member 123 to open the second entrance E2 and close the first entrance E1, for example. In this manner, when abnormality occurs during transport, such as when normal diversion cannot be performed due to abnormality such as belt lock, a coin delivered from the transport unit 14 into the returning passage 12 is directly returned to the feeder 13 through the second passage 12_2 without being reserved in the reservoir 122. In this manner, a coin that cannot be normally transported can be immediately sent to the recognition unit 15, and recognition can be quickly performed again.

When the CPU 16 supplies a coin in the reservoir 122 in a dispense preparation operation (see FIG. 10C), the CPU 16 controls the gate member 123 to open the first entrance E1 and close the second entrance E2, for example. At this time, the CPU 16 performs the control to close the shutter 121 making up the reservoir 122. In this manner, coins can be supplied to the reservoir 122.

In this manner, the reservoir 122 is composed of the first passage 12_1 of the returning passage 12 and the shutter 121. In other words, the reservoir 122 is configured by sealing a corner of the returning passage 12 with the shutter 121. Specifically, in the coin processing device 1, it is not necessary to provide a dedicated configuration for the reservoir 122. In this manner, in the coin processing device 1, the reservoir 122 can be provided in a space-saving and low-cost manner.

Note that, as described above with reference to FIG. 10B, the reservoir 122 ejects all reserved coins to the feeder 13 in the dispensing operation. The ejection of coins by the reservoir 122 is executed when the shutter 121 is opened under the control of the CPU 16.

As described above, the opening and closing of the shutter 121 is achieved through rotational movement of the shutter 121 with an arc cross sectional shape around the rotation axis Ar. The arrow in FIG. 12C indicates a movement of the shutter 121 when the shutter 121 is opened from the closed state. In this manner, the shutter 121 is opened and closed through the rotational movement, and thus the space required for the space for the shutter 121 to move out when opened can be minimized. In this manner, the size of the entirety of the reservoir 122 composed of the shutter 121 can be reduced, and in turn, the size of the coin processing device 1 can be reduced.

Note that, as illustrated in FIGS. 12A to 12C, the entirety of the returning passage 12 is tilted at a predetermined angle with respect to the vertical direction. In this manner, a coin delivered from the transport unit 14 into the returning passage 12 falls downward with gravity in a sliding manner while making contact with the wall surface making up the returning passage 12. If the returning passage 12 is installed perpendicular to the horizontal direction, a coin delivered from the transport unit 14 into the returning passage 12 may freely fall downward, and in this case, it may damage the gate member 123, the shutter 121, the bottom surface part of the feeder 13 and the like by hitting them at a free fall speed. Since the entirety of the returning passage 12 is tilted, the speed at which the coin slides downward can be set slower than the free fall speed, and thus the gate member 123, the shutter 121, the bottom surface part of the feeder 13 and the like can be prevented from being damaged by the coin.

As illustrated in FIG. 11, the feeder 13 comprises a disk provided with a protrusion at the surface. This disk, as with the returning passage 12, is disposed in a tilted manner at a predetermined angle with respect to the vertical direction, and is rotated in the tilted state by a motor or the like. When coins enter the feeder 13, the coins are reserved at the lower portion of the disk, while the coins are caught by the protrusions one by one along with the rotation of the disk and moved to the upper side. The coins caught by the protrusions and moved to the upper side are fed from a hole provided at the outer periphery part relative to the disk in the feeder 13. The hole is connected to the transport unit 14 making up the transport unit 14. With this configuration, the feeder 13 can feed coins one by one to the transport unit 14.

What is claimed is:

1. A coin storage device comprising:
a pair of side walls at least one of which is disposed in a tilted manner such that a distance between the side walls decreases as the side walls extends downward; and
a transport mechanism disposed between the pair of side walls and configured to form a storage space configured to store a coin together with the pair of side walls, wherein
the transport mechanism comprises a first transport and a second transport, the first transport being disposed at a bottom portion of the storage space and configured to transport the coin in a transport direction that is approximately horizontal and does not intersect the side wall, the second transport being configured to transport the coin upward from the first transport.

2. The coin storage device according to claim 1,
wherein the pair of side walls comprises a first side wall and a second side wall, and
wherein the first side wall is disposed substantially vertically.

3. The coin storage device according to claim 1,
wherein the pair of side walls comprises a first side wall and a second side wall, and
wherein the second side wall is tilted at 45 degrees or greater.

4. The coin storage device according to claim 1, further comprising:
a third side wall disposed between the pair of side walls on an upstream side in the transport direction of the first transport in such a manner as to be orthogonal to each of the pair of side walls; and
a curved surface disposed between the third side wall and the first transport and having a convex curved shape toward a rear side of the coin storage device.

5. The coin storage device according to claim 4,
wherein the transport mechanism comprises a belt provided with a transport surface on which a protrusion configured to catch the coin during transport is formed, and
wherein a recess configured to avoid the protrusion is formed at a lower end portion of the curved surface.

6. The coin storage device according to claim 5, wherein an interval of the protrusion along the transport direction is more than twice a diameter of the coin with the largest diameter to be stored.

7. The coin storage device according to claim 1, wherein a length from an upstream end portion to a downstream end portion of the first transport along the transport direction is smaller than a length from a lower end portion to an upper end portion of the second transport.

8. The coin storage device according to claim 1, wherein a length from an upstream end portion to a downstream end portion of the first transport along the transport direction is more than twice a diameter of the coin with the largest diameter to be stored.

9. The coin storage device according to claim 1, further comprising:
a reception provided at an upper portion of the coin storage device and configured to receive the coin; and
a guide disposed at a position where the coin received via the reception hits, the guide being disposed at an installation angle at which the coin is repelled toward the first transport.

10. The coin storage device according to claim 1, further comprising:
an outlet provided near an upper end portion of the second transport and comprising an opening configured to eject the coin transported by the second transport; and
a lid part provided at the outlet and configured to seal the opening.

11. The coin storage device according to claim 10,
wherein the transport mechanism comprises a belt provided with a transport surface on which a protrusion configured to catch the coin during transport is formed, and
wherein a recess configured to avoid the protrusion is formed at a lower end portion of the lid part.

12. The coin storage device according to claim 10, wherein the opening is larger than a diameter of the coin with the largest diameter to be stored.

13. A coin processing device comprising:
the coin storage device according to claim 10;
a transport mechanism which transports the coin; and
a feeder which feeds to the transport mechanism the coin ejected from the coin storage device,
wherein the outlet is connected to an interior of the feeder.

14. The coin processing device according to claim 13, wherein the coin storage device is detachable from the coin processing device.

15. The coin processing device according to claim 13, further comprising:
a reservoir which reserves a dispensing coin; and
a control circuit which closes the lid part provided between the outlet and the feeder during a dispensing operation or during a depositing operation to the coin processing device, the control circuit being configured to open the lid part during a dispense preparation operation of feeding coin to be used for the dispensing operation from the feeder to the reservoir.
